(19) United States
(12) Patent Application Publication
(10) Pub. No.: US 2011/0318567 A1
(43) Pub. Date: Dec. 29, 2011

(54) ANTI-REFLECTION/ANTI-FOG COATINGS

(75) Inventors: Karlheinz Hildenbrand, Krefeld (DE); Peter Capellen, Krefeld (DE); Friedrich-Kark Bruder, Krefeld (DE)

(73) Assignee: BAYER MATERIALSCIENCE AG, Leverkusen (DE)

(21) Appl. No.: 13/148,975

(22) PCT Filed: Feb. 2, 2010
(86) PCT No.: PCT/EP2010/000609

§ 371 Date: Sep. 14, 2011

(30) Foreign Application Priority Data
Feb. 12, 2009 (DE) 10 2009 008 605.6

(51) Int. Cl. B32B 5/18; B05D 7/24; B05D 3/06; G02B 5/22; C09K 3/18

(52) U.S. Cl. 428/313.9; 252/582; 427/558

(57) ABSTRACT

The invention relates to a composition, comprising a) porous silica nanoparticles, b) one or more organic soluble polymer resins, c) one or more UV-cross linkable reactive diluents, d) solvents and e) a UV-initiator system. The invention further relates to the use of the composition for coating transparent substrates, and to substrates that are coated with formulations of said kind.

The invention relates to a composition containing a) porous silica nanoparticles, b) one or more organically soluble polymer resins, c) one or more UV crosslinkable reactive diluents, d) solvents and e) a UV initiator system, to the use of the composition in the coating of transparent substrates, and to substrates coated with such formulations.

The system as a whole is distinguished by good “anti-reflection” properties (increased transmission) in combination with “anti-fog” properties (reduced tendency to becoming steamed up with water vapour). Depending on the substrate, further mechanical and chemical improvements in the surface properties, for example in the abrasion resistance and chemical resistance, are achieved. On account of their surface hydrophilicity, the substrates so coated can be coated with aqueous formulations by the polyelectrolyte concept.

Improving the properties of coatings by incorporating silica has been known in principle for a relatively long time. By adding silica particles it is thereby possible to improve coatings in respect of, for example, abrasion, scratch resistance, reflection properties, gloss, anti-static properties, flammability, UV resistance, resistance to becoming steamed up with water vapour (anti-fog), wettability with water, and chemical resistance.

Accordingly, there has been no lack of attempts in the past to provide silica-(silicon dioxide-)containing coating compositions having further improved overall properties in respect of the above features. However, it has not hitherto been possible to combine all those features, or specific combinations of features, in particular the combination described hereinbelow, in a satisfactory manner in one coating system.

DE 103 11 639 A1 describes moulded bodies provided with anti-static properties, and a process for the production thereof. In order to achieve the object, surface-coating systems comprising acrylate-containing binders, alcoholic solvents, nano-scale electrically conductive metal oxides, nano-scale inert particles such as silicon dioxide and, optionally, further additives such as, for example, dispersing aids are described in this connection. The mean particle size of the inert nanoparticles that are used is from 2 nm to 100 nm, such nanoparticles being used in amounts of from 0.1 wt. % to 50 wt. %, based on the dry film.

In JP-A-61-181809 there is disclosed a UV-curable composition for coatings having good adhesion properties as well as high abrasion resistance, comprising α,β-unsaturated carboxylic acids and colloidal silicon dioxide particles dispersed in water or low-valent alcohols.

JP 2006-348375 A describes anti-fog coatings comprising from 20 wt. % to 99 wt. % of a mixture which consists of from 0 wt. % to 80 wt. % fine particles, for example silicon dioxide, and from 100 wt. % to 20 wt. % of a plastics material as well as from 0.5 wt. % to 30 wt. % of a sulfosuccinate having two anionic substituents.

Surface-coating compositions based on polyfunctional acrylic acid esters for the production of coatings having high transparency, weathering stability and scratch resistance are described in EP-A 0 050 996. In addition to the mentioned acrylic acid derivatives, the compositions contain a polymerisation initiator as well as inorganic fillers such as, for example, silicon dioxide having mean particle diameters of from 1 nm to 1 μm and a refractive index of from 1.40 to 1.60.

In U.S. Pat. No. 4,499,217, anhydrous surface-coating compositions comprising colloidal silicon dioxide having mean particle diameters of from 10 μm to 50 μm and heat-curing compounds, for example melamine-alkyd resins, are described. The cured coatings have good abrasion resistance, good adhesion to various substrates, and chemical and heat resistance.

JP 2001-019874 A discloses compositions comprising (poly)ethylene glycol (poly)methyl methacrylate, acrylamides, photoinitiators, dispersing aids and silica for the production of coatings having high adhesion and increased scratch resistance.

WO 2006/049008 A1 describes a hydrophilic coating based on silica particles which are dispersed in a high-boiling solvent, such as N,N-dimethylacetamide; an alcoholic solution of a non-ionic surfactant (L-77) is added to the dispersion, and then tempering is carried out for 10 minutes at 100° C. The coating yields a hydrophilic surface, it being possible to achieve wetting angles of 20° or less with water. This process is used for the coating of spectacle lenses in respect of “anti-fog” properties. However, these conditions are not suitable for coatings on plastics substrates because of their sensitivity to the solvents used here.

A pourable formulation consisting of a mixture of an organic solution of polyvinylbutyral and an alcoholic dispersion of colloidal silica is described in U.S. Pat. No. 4,383,057. Based on dry weight, the composition can consist of from 20 wt. % to 95 wt. % polyvinylbutyral and from 80 wt. % to 5 wt. % silica. With regard to improving the stability values, such as scratch resistance, chemical resistance and flammability, the polymer polyvinylbutyral is crosslinked, for which purpose there are used, for example, methylolmelanines modified with alkyl ethers. No further details are given as regards surface properties, such as hydrophilicity or water wetting angles. As compared with the present application, the formulations are not UV-crosslinkable.

If, as described in WO 2006/048277 A, surfaces having particularly high and dense silica structures are to be produced, the deposition of silica is often carried out locally by flame hydrolysis from silica precursors, for example from hexamethyldisilazane or tetraethoxysilane. The hydrophobic nature of these coatings can be further enhanced by the incorporation of fluoroalkylsilanes.

EP-A 337 695 discloses silicon dioxide dispersions for the abrasion-resistant coating of solid, in particular transparent substrates. The dispersions contain colloidal silicon dioxide having particle sizes less than 100 nm, preferably less than 75 nm, particularly preferably less than 50 nm, dispersed in a protically substituted ester or amide of an acrylic or methacrylic acid. From 0.1 to 2.5 parts by weight of silicon dioxide are used per part by weight of unsaturated monomer that is employed. After addition of a photoinitiator, the dispersions can be cured on suitable substrates by UV radiation.

EP-A 0 505 737 describes UV-crosslinkable acrylate systems containing methacrylate-functionalised colloidal silica nanoparticles. As well as having outstanding weathering properties, the corresponding surface coatings exhibit good abrasion values, for example Taber haze of 6-8% after 500 cycles. The methacrylate-functionalised silica nanoparticles are prepared from methacryloylpropyltrimethoxy-silane and colloidal silica nanoparticles. Acrylate-modified silica nanoparticles have in the meantime also become available commercially, for example under the name “Nanocryl” from Nanoresins or “Highlink Nano” from Clariant. These products, which are supplied as anti-scratch and anti-abrasion additives, are not very narrowly defined in terms of their properties because of their complex chemistry.

WO 08/005,412 A describes a UV-crosslinkable composition containing unmodified, protonated silica nanoparticles, urethane acrylate, polar solvent and a UV initiator system, the amount by weight of unmodified, protonated silica nanoparticles exceeding the content of urethane acrylate and being at least 50.1 wt. %, based on the dry weight of the coating, the use of the composition in the coating of substrates, and substrates coated with such formulations.

These coatings are distinguished by very good scratch resistance, low haze values, good recoatability and good adhesion to various substrates. However, a markedly increased transmission, or reduced reflection, is not achieved with these coatings.

In “Technische Optik” (G. Schröder, 1998, Vogel Verlag), the following conditions are formulated for achieving minimal reflection or maximum transmission of electromagnetic waves in coated substrates:

A reduction in reflection by interference is achieved by applying an intermediate layer of refractive index n_{b} between air (refractive index n:1.0) and transparent substrate (refractive index nₛ). An optimum reduction in reflection is achieved when the refractive index of the coating n_{b} reaches the value from \sqrt{nₛ}. With regard to the optimum layer thickness, the relationship d_{b}:λ/4nₛ applies. Accordingly, for the visible wavelength range (380-780 nm), lower layer thicknesses are to be established than for longer-wave electromagnetic waves, for example from the infrared range (heat rays).

If the optimum values are not achieved, the anti-reflection effect is reduced.

Porous silica and anti-reflection coatings thereof for glass are already known. For example, WO 97/07056 A discloses monodisperse, porous, spherical particles consisting substantially of SiO₂ having a pore size of from 2 to 20 nm, the preparation of those particles and their use in the production of derivatised silica gel. Porous silica anti-reflection coatings for glass, produced from sols containing [SiOₓ(OH)_{y}]ₙ particles and comprising a first particle fraction having a first particle size range and a second particle fraction having a second particle size range, are described in WO 03/027015 A and in WO 03/027034 A. However, for the production of sufficiently stable anti-reflection coatings for glass, temperatures close to the glass transition temperature of glass are required. It is therefore not possible to transfer the described coating compositions and coating processes with curing conditions of several hundred ° C. to plastics.

Accordingly, it is an object of the present invention to provide transparent coating systems from which anti-reflection coatings can be produced at moderate temperatures, so that it is possible to coat, in addition to glass, also transparent substrates having lower processing temperatures, such as plastics. The coatings are to achieve increased transmission, or reduced reflection, and at the same time are to exhibit anti-fog properties. In addition, the coating surfaces according to the invention are to exhibit good adhesion to various substrates. Transparent substrates of plastics are to exhibit increased resistance to weathering, improved anti-static properties, increased chemical resistance, as well as improved affinity in respect of recoatability with hydrophilic compositions, in particular with dilute aqueous polyelectrolyte solutions. It is to be possible to apply the compositions according to the invention to the substrates in question by simple technologies, such as dipping, spraying or flooding.

It has now been found, surprisingly, that transparent systems containing coating compositions which are characterised in that they contain specific silica nanoparticles in one or more organically soluble polymer resins and a UV-crosslinked component possess the required combination of improved transmission, reflection, anti-fog, affinity and surface properties.

Accordingly, the present invention relates to a composition containing
a) from 5 to 15 parts by weight of porous silica nanoparticles,
b) from 0.5 to 6 parts by weight of one or more organically soluble polymer resins,
c) from 0.2 to 3.0 parts by weight of one or more UV-crosslinkable reactive diluents,
d) solvents,
e) from 0.02 to 0.1 part by weight of a UV initiator system.

Preferably from 75 to 95 parts by weight of solvent are present, but higher dilutions are also possible, which then yield thinner surface-coating layers. In a particularly preferred embodiment, the composition contains a) from 8 to 12 wt. % porous silica nanoparticles, b) from 1 to 4 wt. % of one or more organically soluble polymer resins, c) from 0.5 to 2.0 wt. % reactive diluent, d) from 80 to 90 wt. % solvent and from 0.03 to 0.1 wt. % UV initiator. It has been found, surprisingly, that a coating with the composition according to the invention permits very good product properties in the coated product. The coatings have refractive indices n_{B}<1.45, preferably <1.40 and most particularly preferably <1.35.

Component a), porous silica nanoparticles, is in the form of a dispersion in an organic solvent, preferably in at least one alcohol, particularly preferably in 1-methoxy-2-propanol (MOP). The particle content of the dispersion is preferably in the range from 10 to 25 wt. %, particularly preferably from 18 to 22 wt. % (based on the dispersion).

Porous silica nanoparticles within the scope of the present invention are silica nanoparticles with which porous coatings on glass having a refractive index close to 1.22 can be produced. Reference is made, for example, to M. Kursawe, V. Hilarius, G. Pfaff, Merck KGaA, “Beschichtungen über Sol-Gel Prozesse” in “Moderne Beschichtungsverfahren”, Wiley-VCH, 2005, in which porous silica particles and their use for the coating of glass are described. Reference is likewise made here to the prior art mentioned above, in which porous silica nanoparticles are used in the sol-gel process for anti-reflection coatings on glass which are cured at temperatures of several hundred ° C.

The silica nanoparticles used can be present in monodisperse form (i.e. with monomodal particle size distribution), as described in WO 97/07056 A, or can exhibit bimodal distribution curves, for example a fraction having particle diameters in the range from 1 to 15 nm and a second fraction having particle diameters in the range from 15 to 60 nm, as described in WO 03/027015 A. Preference is given to the use of monodisperse porous silicon dioxide (silica) nanoparticles having particle diameters of in the mean (d₅₀) from 10 to 50 nm, particularly preferably from 20 to 40 nm, or particles having multi-modal, preferably bimodal, particle size distribution containing various fractions of particles having diameters in the range from 1 to 10 nm, preferably from 3 to 7 nm, and from 10 to 30 nm, preferably from 20 to 25 nm. The particle diameter is here based on a weight-average particle size and the mean particle size d₅₀ is based on the value at which 50 wt. % of the particles have a diameter less than or equal to d₅₀. The particle size distribution can be determined, for example, by ultracentrifugation. Most particular preference is given to the use of the porous silica nanoparticles “Silicon dioxide Hybrid-Sol Siosol™” Article no. 102264 from Merck KGaA, Darmstadt.

Component b) is organically soluble polymer (polymer resin), preferably polyvinyl (co)polymers, in particular polyvinyl acetate, or polyacryl (co)polymers, in particular polymethyl methacrylate or polyethyl methacrylate. Polymer mixtures can also be used.

As component c), reactive diluent, there are used UV-crosslinkable, ethylenically unsaturated monomers having aliphatic or cycloaliphatic radicals. Particular preference is given to low molecular weight acrylates and methacrylates. Examples are hexanediol diacrylate (HDDA), dipentaerythritol hexaacrylate (DPHA), tripropylene glycol diacrylate (TPGDA), pentaerythritol triacrylate (PETA), pentaerythritol tetraacrylate, neopentyl glycol diacrylate, hydroxyethyl acrylate, hydroxyethyl methacrylate (HEMA), bis-[methacryloyloxy]-ethyl]phosphate, glycidyl acrylates and methacrylates, as well as functional silanes, such as 3-meth-acryloxypropyltrimethoxysilane. Mixtures of these reactive diluents can also be used.

Component d), solvents, is polar, preferably protic, solvents in which both the porous silica nanoparticles and the remaining components, in particular the binders of the formulation, are compatible. There are suitable in particular alcohols, such as methanol, ethanol, isopropanol, ethylene glycol, propylene glycol (1,2-propanediol), propyl glycol (ethylene glycol n-propyl ether), methoxypropanol (MOP, 1-methoxy-2-propanol) or diacetone alcohol (DAA, 4-hydroxy-4-methyl-2-pentanone), ketones, such as acetone, methyl ethyl ketone, methyl isobutyl ketone, esters, such as ethyl acetate, butyl acetate and propylene glycol monomethyl ether acetate, ethers, such as ethylene glycol n-propyl ether, tetrahydrofuran, as well as amidic solvents, such as N,N-dimethylacetamide or N-methylpyrrolidone. Most particular preference is given to alcohols, such as MOP and/or DAA. Of course, it is also possible to use solvent mixtures, which can also contain small amounts of solvents which are unsuitable per se in pure form, such as toluene.

Component d), the UV initiator system, is systems which, in the air or under inert gas, initiate polymerisation of the acrylate components under irradiation with UV light. Such systems, which are usually added in amounts of several wt. % (approximately from 2 to 10) based on the amount of acrylate used, are obtainable, for example, under the product name “Irgacure®” or Darocure®. Mixtures, such as, for example, Irgacure 184/Darocure TPO, are frequently also used. Irgacure 184® is hydroxy-cyclohexyl phenyl ketone, and Darocure TPO® is diphenyl (2,4,6-trimethylbenzoyl)-phosphine oxide.

Instead of being carried out by UV treatment, the subsequent crosslinking of the coating system can also be carried out by electron beam treatment or by UV treatment in combination with electron beam treatment.

With regard to the substrates which can be further improved by the application of the surface-coating formulations according to the invention, there is a wide range of possible choices of transparent and translucent but also non-transparent materials within the context of the present invention, such as ceramics, marble or wood. Because of the excellent “transparent protective properties” of the novel surface-coating systems, highly transparent substrates are naturally preferred. Most particular preference is given to transparent thermoplastic polymers, for example of polycarbonate (Makrolon®, Apec®) or polycarbonate blends (Makroblend®, Bayblend®), polymethyl methacrylate (Plexiglas®), polyesters, cycloaliphatic olefins, such as Zeonor®, as well as glass.

Polycarbonates for the compositions according to the invention are homopolycarbonates, copolycarbonates and thermoplastic polyester carbonates.

The polycarbonates and copolycarbonates according to the invention generally have mean molecular weights (weight average) of from 2000 to 200,000, preferably from 3000 to 150,000, in particular from 5000 to 100,000, most particularly preferably from 8000 to 80,000, in particular from 12,000 to 70,000 (determined by GPC with polycarbonate calibration).

For the preparation of polycarbonates for the compositions according to the invention, reference is made, for example, to “Schnell”, Chemistry and Physics of Polycarbonates, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718 and finally to Dres. U. Grigo, K. Kircher and P. R. Müller, “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299. Preparation is preferably carried out by the interfacial process or the melt transesterification process.

Preference is given to homopolycarbonates based on bisphenol A and copolycarbonates based on the monomers bisphenol A and 1,1-bis-(4-hydroxyphenyl)-3,3,5-trimethylcyclohexane. These or other suitable bisphenol compounds are reacted with carbonic acid compounds, in particular phosgene or, in the melt transesterification process, diphenyl carbonate or dimethyl carbonate, with the formation of the polymers in question.

There can be added to the formulations as further components coating additives, for example flow agents, as well as stabilisers against UV light, such as triazoles and sterically hindered amines.

As already mentioned, the compositions according to the invention can be used as abrasion- and scratch-resistant coatings having good anti-reflection and anti-fog properties, that is to say as protective coatings and also as substrate layers for further coatings.

Typical layer thicknesses are in the range from 0.2 to 200 μm, preferably from 1 to 50 μm, most preferably from 2 to 20 μm.

Fields of use of the anti-reflection, abrasion- and scratch-resistant, highly transparent protective coatings are in areas in which glass is replaced by plastics, such as polycarbonate, for example in the automotive sector, in architectural glazing or in optical fields, such as spectacle lenses. As compared with known, conventional scratch-resistant coatings, the coatings according to the invention, in addition to their particularly good anti-reflection properties, also exhibit anti-fog properties as well as anti-static effects. Anti-fog properties can easily be demonstrated by breathing on the corresponding surfaces, steaming up by moisture from the air being prevented in the case of good anti-fog properties.

The present invention further provides moulded bodies having a surface which is coated with the composition according to the invention or by the process according to the invention.

The present invention further provides multi-layer products containing a substrate layer which has a second layer on at least one side, the second layer being produced from a composition according to the invention. The multi-layer products can contain a further layer of cationic or zwitterionic compounds.

### EXAMPLES

### A. Components

### 1. Silica Nanoparticles

a. Silicon Dioxide Hybrid-Sol Siosol™
Porous silicon dioxide nanoparticles from Merck (monomodal particle size distribution with d₅₀=33 nm), 21 wt. % dispersion in 1-methoxy-2-propanol (MOP) or 21.5 wt. % dispersion in diacetone alcohol

b. Highlink® Nano G Silica Organosol:
30 wt. % dispersions of non-porous silica nanoparticles in alcohols, such as isopropanol, ethylene glycol or propyl glycol, having a mean particle size of 13 nm. These particles were used in a comparison example.

### 2. Heat-Curing Polymer Resins

a. Degalan® M 912: Bulk polymer, granulated, based on methyl methacrylate from Degussa. Molecular weight (Mw): 180,000 g/mol, Tg (glass transition temperature): 122° C.
b. Elvacite® 2041: High molecular weight methyl methacrylate polymer, Lucite International Inc., Mw: 410,000 g/mol, Tg: 105° C.

### 3. UV-Crosslinkable Urethane Acrylates

a. HDDA: 1,6-Hexanediol diacrylate from Alfa Aesar
b. Desmolux U 100: Unsaturated aliphatic urethane acrylate from Bayer MaterialScience AG

### B. Substrates

1. Polycarbonate Sheets (Makrolon® from Bayer MaterialScience AG), Dimensions: 100×150×3 mm, Consisting of:
a. Makrolon® M 2808 (bisphenol A polycarbonate: medium-viscosity bisphenol A polycarbonate, MFR 10 g/10 min according to ISO 1133 at 300° C. and 1.2 kg, without UV stabilisation and mould release agent)
b. Makrolon® Al 2647 (medium-viscosity bisphenol A polycarbonate with UV stabiliser and mould release agent; MFR 13 g/10 min according to ISO 1133 at 300° C. and 1.2 kg)

### 2. Foils

a. Polycarbonate foil: Makrofol® DE 1-1 from Bayer MaterialScience AG, layer thickness: 375 μm, high-gloss on both sides

### C. Test Methods

### Production and Testing of the Coated Products

### a) Refractive Index

The refractive index n_{B} and the imaginary component of the refractive index k (also referred to hereinbelow as the absorption constant k) of the coatings were obtained from the transmission and reflection spectra. To that end, films of the coating having a thickness of approximately from 100 to 300 nm were applied to quartz glass carriers from dilute solution by spin coating. The transmission and reflection spectrum of this multi-layer coating was measured using a spectrometer from STEAG ETA-Optik, CD-Measurement System ETA-RT, and then the layer thickness and the spectral progression of n and k were adapted to the measured transmission and reflection spectra. This is carried out using the internal software of the spectrometer and additionally requires the n and k data of the quartz glass substrate, which were determined beforehand in a blank measurement. k is related to the decay constant of the light intensity α as follows:

$$k = \frac{λ \cdot α}{4 π}$$

λ is the wavelength of the light.

Transmission and reflection: The Lamda 900 photometer from Perkin Elmer is used for the spectroscopy, measurement being carried out according to ASTM E 308 in the wavelength range of from 200 to 2300 nm. Measurement is carried out with the aid of a photometer sphere so that, on perpendicular irradiation, both direct and diffuse components were taken into consideration.

### b) Determination of the Anti-Fog Properties

b.1) Breathing test: Half of the substrate is coated with the coating composition to be tested, and the coated substrate is breathed on. In the case of anti-fog effects, the coated side does not steam up while the uncoated substrate becomes opaque with steam.

b.2) Greenhouse test: The coated sheets are secured to the roof of a model greenhouse at an angle of 60° with the coated side downwards, so that the water-spreading effect can be compared by observing the droplet formation. In the model greenhouse, water is evaporated by means of a heat source so that a temperature of 50° C. and an atmospheric humidity of 100% is established.

The sheets are left under those conditions for 6 hours and then heated in a dry heating cabinet for 4 hours at 40° C. This procedure is then repeated alternately in the model greenhouse and in the drying cabinet until the water-spreading effect disappears (which can be seen by the formation of drops on the sheet). If the water-spreading effect is still present after 80 cycles, the long-term performance is assessed as positive and the test is terminated.

c) The layer thickness is determined by means of a white light interferometer (ETA SPB-T, ETA-Optik GmbH).
d) The adhesion is determined according to DIN EN ISO 2407 (cross-cut test). A cross-cut rating of 0 means that all the cut edges are completely smooth and none of the cross-cut squares has flaked off. A cross-cut rating of 5 means that all the cross-cut squares have flaked off.
e) Haze: The haze is determined according to ASTM D 1003-00 by wide-angle light scattering. The values are given in % Haze (H), low values, for example 1% H, meaning low haze and high transparency, and values less than 1% H meaning excellent transparency.
f) Abrasion test: The wear resistance (abrasion) is determined by means of abrasive disk methods (DIN 53 754) by the increase in scattered light. A model 5151 Taber abrader with CS-10F Calibrase abrasive disks (type IV) was used, with an applied weight of 500 g per disk. The haze values are measured, for example, after 100, 500 or 1000 cycles, low values, for example 0.5% H, meaning excellent abrasion resistance.
g) Yellowness index (YI, ASTM E 313): The YI test is a measure of the yellowing of the test sample by UV light. Low values, for example YI:0.5, mean a low degree of yellowing.
h) Long-term stability and weathering tests

In order to determine the long-term stability, the tests are carried out under the following stress conditions:

Storage in water: The sample is stored for 10 days in water at a temperature of 65+/−2° C. according to ASTM 870-02, the above-mentioned tests being carried out daily.

Boiling test: The samples are placed in boiling water, the above-mentioned values being determined after 0.5, 1, 2, 3 and 4 hours. If the 4-hour boiling test, for example, is passed without damage, good long-term stability can be predicted.

Weathering: As compared with the natural test, accelerated determination of the light/weathering stability of materials is carried out. The most important climatic factors (radiation, heat, moisture, rain) can be simulated using so-called Weather-Ometers®. For example, the so-called Xenon WOM according to ASTM G 155 and the Xenon High Energy Test according to DIN EN ISO 4892-2 are carried out.

### D. Production of the Coatings

### Example 1

### Dissolution of the Polymer Resin

Degalan® M 912: 12.5 g of Degalan M 912 were dissolved at 80° C., with stirring, in 87.5 g of diacetone alcohol (DAA), a clear 12.5% polymer solution being obtained. Viscosity: 94.0 mPa·s±0.3 mPa·s.

### Example 2

### According to the Invention

Preparation of a 15 wt. % pourable formulation containing Degalan M 912 in combination with HDDA and 70 wt. % porous silica nanoparticles based on dry film weight

In a 500 ml glass beaker having a magnetic stirrer, the following components were mixed, with stirring, to form a homogeneous pourable solution:

| | |
|---|---|
| 56.0 g | 12.5% Degalan solution M 912 in DAA (Example 1) |
| 54.0 g | diacetone alcohol |
| 113.0 g | silica nanoparticles Silicon dioxide Hybrid-Sol Siosol ™ |
| | 21% in 1-methoxy-2-propanol (MOP) |
| 3.0 g | 1,6-hexanediol diacrylate (HDDA), Alfa Aesar |
| 0.15 g | Irgacure 184 ® (1-hydroxy-cyclohexyl phenyl ketone, |
| | photoinitiator, CIBA) |

Stirring was then carried out for a further 10 minutes, there being obtained a transparent, colourless pourable solution which was filtered through a 3 μm paper filter into a brown glass bottle.

### Example 3

### According to the Invention

Preparation of a 15 wt. % pourable formulation containing Elvacite® 2041 in combination with HDDA and 70 wt. % porous silica nanoparticles based on dry film weight

A pourable solution was prepared from the following components as described in Example 2:

| | |
|---|---|
| 56.0 g | 12.5% Elvacite 2041 solution in DAA (prepared analogously |
| | to Example 1) |
| 56.0 g | diacetone alcohol |
| 110.5 g | silica nanoparticles Silicon dioxide Hybrid-Sol |
| | Siosol ™, 21% in 1- methoxy-2-propanol (MOP) |
| 3.0 g | 1,6-hexanediol diacrylate (HDDA), Alfa Aesar |
| 0.16 g | Irgacure 184 ® (1-hydroxy-cyclohexyl phenyl |
| | ketone, photoinitiator, CIBA) |

### Example 4

### Not According to the Invention

Preparation of a 15 wt. % pourable formulation containing Elvacite® 2041 in combination with HDDA and 70 wt. % non-porous silica nanoparticles based on dry film weight:

| | |
|---|---|
| 56.0 g | 12.5% Elvacite 2041 solution in DAA (prepared analogously |
| | to Example 1) |
| 56.0 g | diacetone alcohol |
| 110.5 g | silica nanoparticles Highlink ® Nano G Silica |
| | Organosol, 21% in 1-methoxy-2-propanol (MOP) |
| 3.0 g | 1,6-hexanediol diacrylate (HDDA), Alfa Aesar |

### Example 5

### Not According to the Invention

Preparation of a 8 wt. % pourable formulation containing Elvacite® 2041, without reactive diluent (HDDA), and 70 wt. % porous silica nanoparticles based on dry film weight

A pourable solution was prepared from the following components as described in Example 2:

| | |
|---|---|
| 7.0 g | 12.5% Elvacite 2041 solution in DAA (prepared analogously to |
| | Example 1) |
| 11.0 g | diacetone alcohol |
| 18.5 g | nanoparticles: Silicon dioxide Hybrid-Sol Siosol ™, 21% in 1- |
| | methoxy-2-propanol (MOP) |

### Example 6

### Not According to the Invention

Preparation of a 15 wt. % pourable formulation containing Desmolux U 100 and 70 wt. % porous silica nanoparticles based on dry film weight, without organically soluble polymer resin component

A pourable solution was prepared from the following components as described in Example 2:

| | |
|---|---|
| 56.0 g | Desmolux U 100 |
| 10.0 g | diacetone alcohol |
| 114.0 g | nanoparticles: Silicon dioxide Hybrid-Sol Siosol ™, 21% in 1- |
| | methoxy-2-propanol (MOP) |
| 0.5 g | Irgacure 184 ® (1-hydroxy-cyclohexyl phenyl ketone, |
| | photoinitiator, CIBA) |

### Coating of Substrate Sheets

The dispersions described in Examples 2 to 6 were applied to various substrates by flood coating.

In Examples 7 to 13, sheets having the surface dimensions 10×15 cm were used as substrates.

### Substrate 1: Malcrolon® M 2808

### Substrate 2: Malcrolon® Al 2647

The sheets were first cleaned with isopropanol and blown dry with ionised air. The pourable solution applied by flood coating was first exposed to the air for 5 minutes at room temperature (RT) and then dried for 30 minutes at 80° C. The coating was then subjected to UV curing with the aid of a Hg lamp, an energy of about 5 J/cm² being applied.

### Example 7

Sheet of substrate 1, flood coated with a pourable solution according to Example 2. For the anti-fog test and the test for chemical resistance, in each case only half the substrate is flood coated.

### Example 8

### Comparison Example

Sheet of substrate 1, not flood coated

### Example 9

Sheet of substrate 2, flood coated with a pourable solution according to Example 2. For the anti-fog test and the test for chemical resistance, in each case only half the substrate is flood coated.

### Example 10

### Comparison Example

Sheet of substrate 2, not flood coated

### Characterisation of Examples 7 to 10:

In Examples 7 and 9, highly transparent coatings with good adhesion were obtained.
a) Examples 7 and 9—layer thickness;
   Top: 3.1 μm, bottom: 1.4 μm (tapering layer thickness as a result of the flooding process)
b) Haze by means of hazemeter according to ASTM 1003-00
   Examples 7 and 9—Haze: 0.3%, this low value corresponding to excellent transparency.
   In the case of the uncoated substrate (Example 8), on the other hand, a haze value of 0.9% was determined.
c) Abrasion resistance by abrasive disk methods (Taber test) DIN 53 754 with Calibrase CS-10F disks
   Examples 7 and 9—ΔHaze: 9% after 100 cycles.
   In the case of the uncoated substrates (Examples 8 and 10), on the other hand, a markedly higher abrasion of Δhaze: 29% was determined by the same method.
d) Examples 7 and 9—The tape test after cross-cutting showed completely smooth edges and could thus be evaluated with a rating of 0 according to DIN EN ISO 2409. The coating exhibits perfect adhesion to both substrates.
f) Anti-fog properties: The sheets, only half the surface of which was coated according to the invention, were breathed on. The uncoated part steamed up and became opaque, while no change could be detected in the coated part, that is to say the transparency was retained completely.
g) Examples 7 and 9—Refractive index of the coating: 1.315
h) Transmission/reflection: While the transmission in the case of the uncoated sheets (Examples 8 and 10) is about 90% in the visible wavelength range, a value of approximately from 93 to 95% could be achieved by means of the coating (Examples 7 and 9).
i) Chemical resistance: While the uncoated side of the sheets, only half the surface of which was coated according to the invention, immediately became cloudy, as expected, the coated side of the substrate exhibited markedly better resistance (virtually no cloudiness) to acetone.

### Example 11

Sheet of substrate 1, flood coated with a pourable solution according to Example 3
Layer thickness (flooded coating): 1.5-3.0 μm
Haze: 0.43%
Refractive index: 1.36
Abrasion resistance: ΔHaze (100 cycles): 11%
Transmission (450-800 nm): about 93-95%
Anti-fog: The coated side did not steam up when breathed on, while the uncoated surface became cloudy when breathed on.

### Example 12

### Comparison Example

Sheet of substrate 1, flood coated with a pourable solution according to Example 4

After UV crosslinking, a coating having fine hairline cracks was obtained. No further tests were therefore carried out.

### Example 13

### Comparison Example

Sheet of substrate 1, flood coated with a pourable solution according to Example 5

After UV crosslinking, a transparent, fault-free coating having the following properties was obtained:
Layer thickness: 0.8-1.4 μm
Haze: 0.13%
Refractive index: 1.48

Surprisingly, the coating described here did not result in a marked fall in the refractive index and accordingly did not yield noteworthy anti-reflection properties, for which reason no further tests were carried out.

### Example 14

### Comparison Example

Sheet of substrate 1, flood coated with a pourable solution according to Example 4 (pourable solution with non-porous silica nanoparticles):
Layer thickness (flooded coating): 2.0-3.5 μm
Haze: 0.43%
Refractive index: 1.48
Abrasion resistance: ΔHaze (100 cycles): 11%
Transmission (450-800 nm): about 91%
Anti-fog: The coated side did not steam up when breathed on, while the uncoated surface became cloudy when breathed on.

As the results show, replacing the porous silica nanoparticles (Silicon dioxide Hybrid-Sol Siosol™ from Example 3) with non-porous analogues (Highlink® Nano G Silica Organosol from Example 5) yielded coatings having a markedly higher refractive index and a lower transmission (reduced anti-reflection effect).

### Continuous Coating of Substrate Foils

### Example 15

Coating of Makrofol® DE 1-1 foil by means of a pilot coating installation:

A 375 μm thick polycarbonate foil (Makrofol® DE 1-1) was coated with the above-described pourable solution, the following pouring parameters being observed:
Belt speed: 2 m/min
Application method: reverse rollercoating
Drying with warm air: 1st zone: 50° C., 2nd zone: 90° C., 3rd zone: 100° C., each of the dryer zones is 1 m long, so that a total dwell time of 1.5 minutes results.
Drying with IR radiator: Following the warm-air zone drying, further drying by means of IR radiators is carried out at a T of 75° C.
UV crosslinking: Following the IR drying, crosslinking of the acrylate components is effected by UV crosslinking by means of a Hg vapour lamp corresponding to a UV dose of about 550 mJ/cm².

A fault-free, highly transparent coating having a thickness of about 360 nm was obtained.

Testing of the foil with the aid of the above-described methods yielded the following measurement results:
Haze: 0.3%
Refractive index: 1.315
Abrasion resistance: ΔHaze (100 cycles): 9%
Adhesion to M 2808: very good: rating 0
Transmission (450-800 nm): about 93-95%
Anti-fog: The coated side of the substrate did not steam up when breathed on, while the uncoated surface became cloudy when breathed on.

1-14. (canceled)

15. A composition comprising
a) from 5 to 15 parts by weight of porous silica nanoparticles,
b) from 0.5 to 6 parts by weight of one or more organically soluble polymer resins,
c) from 0.2 to 3.0 parts by weight of one or more UV crosslinkable reactive diluents,
d) a solvent, and
e) from 0.02 to 0.1 part by weight of a UV initiator system.

16. The composition according to claim 15, wherein the silica nanoparticles are dispersed in an organic solvent.

17. The composition according to claim 15, wherein the polymer resin is selected from the group consisting of polyvinyl (co)polymers and polyacryl (co)polymers.

18. A coating composition comprising the composition according to claim 15, wherein the coating composition has a refractive index n_{B} of less than 1.45.

19. The coating composition according to claim 18, wherein the refractive index n_{B} is less than 1.40.

20. The coating composition according to claim 18, wherein the refractive index n_{B} is less than 1.35.

21. The composition according to claim 15, wherein
a) the porous silica nanoparticles have a monomodal particle size distribution and a weight-average particle diameter d₅₀ of from 10 to 50 nm, or have a bimodal particle size distribution, having two fractions, one having a mean particle diameter d₅₀ of from 1 to 10 nm and one having a mean particle diameter d₅₀ of from 10 to 30 nm;
b) the one or more organically soluble polymer resins comprises polymethyl (meth)acrylate;
c) the one or more UV crosslinkable reactive diluents comprise UV- or electron beam-crosslinkable, ethylenically unsaturated low molecular weight acrylate or methacrylate having fewer than 30 carbon atoms and having aliphatic or cycloaliphatic radicals;
d) the solvent comprises one or more alcohol(s); and
e) the UV initiator system comprises hydroxy-cyclohexyl phenyl ketone or diphenyl (2,4,6-trimethylbenzoyl)-phosphine oxide.

22. A coated surface, wherein the coating comprises the composition according to claim 15.

23. A process for the coating of surfaces, comprising applying the composition according to claim 15 to a surface and irradiating the coated surface with UV light.

24. A moulded body having a surface coated with the composition according to claim 15.

25. A moulded body having a surface coated by the process according to claim 23.

26. A moulded body of a transparent thermoplastic polymer, comprising a surface coating which comprises the composition according to claim 15.

27. A multi-layer product comprising a substrate layer which has a second layer on at least one side, wherein the second layer is produced from compositions according to claim 15.

28. The multi-layer product according to claim 27, wherein the substrate layer consists of a transparent thermoplastic polymer.

29. The multi-layer product according to claim 28, wherein the transparent thermoplastic polymer is polycarbonate.
